(19) United States
(12) Patent Application Publication
(10) Pub. No.: US 2013/0054370 A1
(43) Pub. Date: Feb. 28, 2013

(54) SYSTEM AND METHOD FOR COMMUNICATION BASED ON LOCATION

(71) Applicant: PHILIP LEHMANN, Witten (DE)

(72) Inventor: PHILIP LEHMANN, Witten (DE)

(73) Assignee: dinkystuff.com GmbH, Witten (DE)

(21) Appl. No.: 13/216,296

(22) Filed: Aug. 24, 2011

(51) Int. Cl. G06Q 30/00

(52) U.S. Cl. 705/14.58

(57) ABSTRACT

A method and a system for communication between a seller and a potential buyer are provided. The method and the system comprises at least one server in communication with a wireless data network and a mobile wireless device in communication with the at least one server using the wireless data network. The system and the method for communication between the seller and the potential buyer facilitates searching based on a distance from the seller and simplifies a listing procedure of network based classified advertisements.

### FIELD OF THE INVENTION

The present invention relates to a system and a method for communication between a seller and a potential buyer using at least one mobile wireless device.

### BACKGROUND OF THE INVENTION

Network based classified advertisements offer many ways for users of such services to search for items or services. The item or service desired by a potential customer may be searched for using a word or series of words, for example. In addition to using a word or a series of words to locate the item or service desired, a geographic area may be designated as well. Typically, the geographic area may be defined as a zip code, a city, or a state. However, such geographic boundaries may yield search results unusable to the potential customer. In urban areas, the search results may be too numerous for the potential customer to adequately “browse” through. In contrast, in rural areas, the search results may be too few or too dispersed to provide the potential customer with any useful results.

In addition to the imprecision of geographical designations, many sellers who use network based classified advertisements find a listing procedure associated with such advertisements to be time consuming. Typically, the listing procedure is performed from a personal computer. The listing procedure typically includes logging into an account associated with a network based classified advertisements provider, creating a description of the classified advertisement, uploading content (such as images) to be displayed alongside the description, and providing contact information for a potential customer to initiate a transaction. Many sellers find such a process to be too time consuming to justify selling items below a particular price. Additionally, when personal delivery or pickup of the sold item is not practical, one or both of the parties must bear the expenses associated with shipping the sold item.

It would be advantageous to develop a system and a method for communication between a seller and a potential buyer using at least one mobile wireless device that facilitates searching based on a distance from the seller and simplifies a listing procedure of network based classified advertisements.

### SUMMARY OF THE INVENTION

Presently provided by the invention, a system and a method for communication between a seller and a potential buyer using at least one mobile wireless device that facilitates searching based on a distance from the seller and simplifies a listing procedure of network based classified advertisements, has surprisingly been discovered.

In one embodiment, the present invention is directed to a method of communication between a seller and a potential buyer. The steps of the method comprise providing at least one server in communication with a wireless data network, receiving at the at least one server a first user input from the seller, the first user input including a first geographical location associated with the seller, publishing an offer to the at least one server, the offer including at least a portion of the first user input from the seller, communicating a second geographical location to the at least one server using the wireless data network, the second geographical location associated with a mobile wireless device of the potential buyer, calculating a distance between the first geographical location and the second geographical location, and determining by the at least one server whether the offer may be viewed on the wireless mobile device based on the distance between the first geographical location and the second geographical location, and viewing the offer by the potential buyer on the mobile wireless device, wherein the distance between the first geographical location and the second geographical location is less than or equal to a pre-selected distance of the potential buyer.

In a second embodiment, the present invention is directed to a system for communication between a seller and a potential buyer. The system comprises at least one server in communication with a wireless data network and a mobile wireless device in communication with the at least one server using the wireless data network. The at least one server is configured to receive and store a first user input from the seller. The first user input includes a first geographical location associated with the seller. The at least one server publishes an offer to the server, the offer including at least a portion of the user input from the seller. The mobile wireless device provides a second geographical location to the at least one server. The second geographical location is associated with the potential buyer. The at least one server calculates a distance between the first geographical location and the second geographical location. The at least one server determines whether the offer may be viewed on the wireless mobile device based on the distance between the first geographical location and the second geographical location. The at least one server makes the offer viewable to the mobile wireless device when the distance between the first geographical location and the second geographical location is less than or equal to a pre-selected distance of the potential buyer.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a block diagram of a system for communication between a seller and a potential buyer;

FIG. 2 is a block diagram illustrating a typical interaction between a user and the client interface of the system for communication shown in FIG. 1;

FIG. 3 is a block diagram illustrating a user profile of the system for communication shown in FIG. 1;

FIG. 4 is a block diagram illustrating a process by which the seller generates an offer using the system for communication shown in FIG. 1;

FIG. 5 is a block diagram illustrating an exemplary procedure by which the seller interacts with the system for communication shown in FIG. 1 to generate the offer; and

FIG. 6 is a block diagram illustrating a process by which a potential buyer performs a search or browses for the offer using the system for communication shown in FIG. 1.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

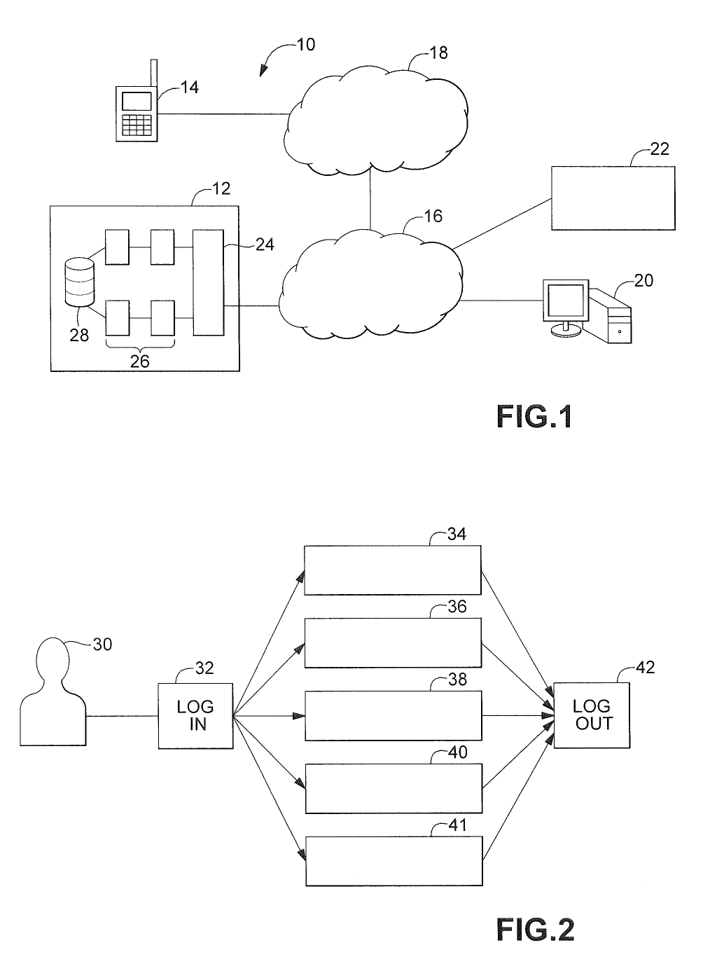

Turning now to FIG. 1, a system for communication 10 is shown comprising of an application platform 12, and a mobile wireless device 14. The application platform 12 is in communication with the mobile wireless device 14 via a network 16 (the internet, for example) and a wireless data network 18. A user machine 20 and a remote application 22 are also shown in communication with the application platform 12 via the network 16; however, it is understood that the system for communication 10 may be operated without the user machine 20 and the remote application 22. A user of the system for communication 10 may be a seller or a potential buyer of a good or a service. The seller uses the system for communication 10 to post an offer for the good or the service to the application platform 12 and to communicate with the potential buyer. The potential buyer uses the system for communication 10 to search and/or browse a plurality of offers and to communicate with the seller.

The application platform 12 comprises a plurality of servers in communication with one another. The application platform 12 includes a client interface 24, at least one operations server 26, and a data storage device 28. The application platform 12 provides an interface for the user of the system for communication 10 to interact with and hosts programs facilitating the receiving, manipulating, and sending of data between one of the mobile wireless device 14 and the user machine 20, the data storage device 28, and the remote application 22.

The mobile wireless device 14 is a portable electronic device capable of sending and receiving information from the network 16. As non-limiting examples, the mobile wireless device 14 may be one of a mobile phone, a personal media player, a tablet computer, a notebook computer, a global positioning system (GPS) device, an entertainment receiver installed in a vehicle, a personal digital assistant, a handheld gaming device, and an e-book reading device. Further, it is understood that other devices may be used.

The mobile wireless device 14 may connect to the network 16 using the wireless data network 18. As non-limiting examples, the wireless data network 18 may be a cellular network provided by a network provider, a wireless network access point (such as a router) in communication with the network 16, or an ad-hoc network formed by a plurality of devices capable of communicating wirelessly. The mobile wireless device 14 may be capable of determining a first geographical location. The first geographical location is a location of the mobile wireless device 14 or a location designated by a user of the application platform 12.

The operations server 26 is at least one computer in communication with the client interface 24 and the data storage device 28. As shown in FIG. 1, the operations server 26 may comprise a plurality of computers in communication with one another. Each of the computers forming the operations server 26 may be dedicated to a function of the application platform 12.

The data storage device 28 is a computer providing a database service as is known in the art. The data storage device 28 is in communication with the operations server 26. As mentioned hereinabove, the data storage device 28, upon request by the operations server 26, stores and retrieves a first user input, the offers generated by the operations server 26, the user profiles, a plurality of the first geographical locations, and the indexing words. It is understood that the data storage device 28 may also be used to store any other information used by the system for communication 10.

FIG. 2 is a block diagram illustrating a typical interaction between a user 30 and the client interface 24. As is known in the art, the user 30 logs in to the system for communication 10 with a username and password combination that is recognized by a log in function 32 of the operations server 26. Further, it is understood the system for communication 10 may be configured to permit access to portions of the application platform 12 without the need for logging in to the system for communication 10; such as through the use of browser cookies and application information contained on the mobile wireless device 14.

Once logged in to the system for communication 10, the user 30 has access to a plurality of functions provided by the application platform 12. The operations server 26 is configured to generate the offer associated with the good or the service the user 30 desires to sell using an offer generating function 34, to permit the user 30 to search or browse listings located on the data storage device 28 using a search/browse function 36, to manage the remote applications 22 using an applications management function 38, to view and send messages using a messaging function 40, and to edit a plurality of functions of the operations server using a settings function 41. It is understood that the client interface 24 may be configured to provide other functions not illustrated, such as running of reporting functions, modification of interface settings, as well as other functions. Upon the user 30 having performed the desired tasks, the user 30 directs the client interface 24 to log out the user 30 from the system for communication 10 using a logout function 42.

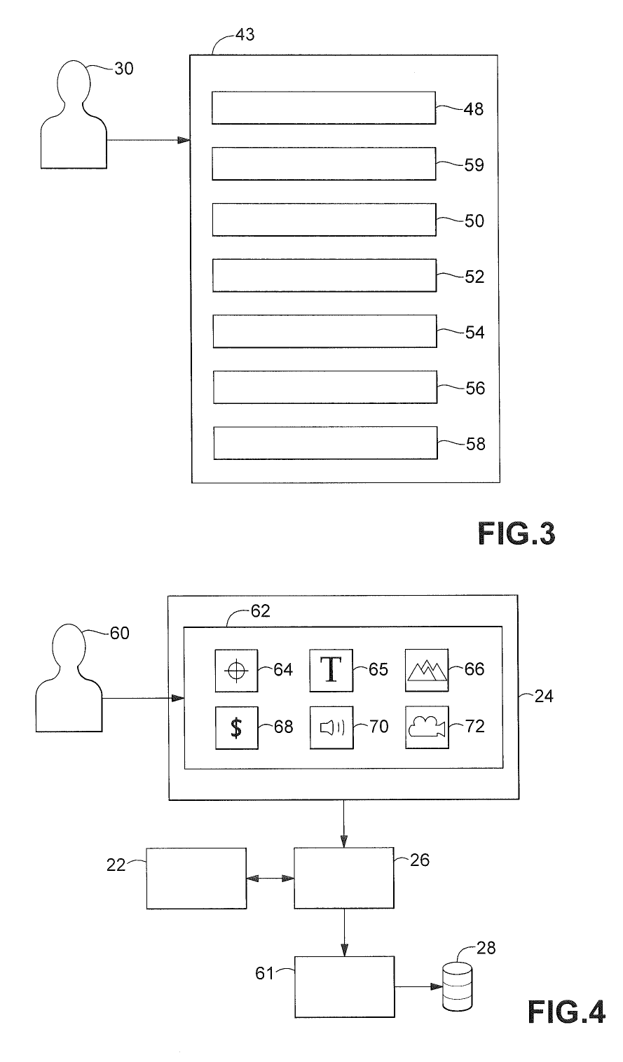

A user profile 43, as shown in FIG. 3, comprises data entered by the user 30 and settings used by the operations server 26. The user profile 43 may be one of a seller profile and a potential buyer profile; however, it is understood the seller profile and the potential buyer profile may be configured similarly with respect to the operations server 26, and that the operations server 26 may not distinguish between the seller profile and the potential buyer profile. The user profile 43 may be edited by the user 30 using the settings function 41, or a similar administrative function.

The seller profile includes data entered by the seller and a plurality of operation server settings 48 used by the operations server 26 to determine how the operations server 26 generates the offer associated with the good or the service the seller desires to sell. As non-limiting examples, the seller profile may include a contact information 50 of the seller, a first geographical location 52 designated by the seller, a transaction history 54 with respect to the system for communication 10, and a feedback 56 from users who have purchased goods or services from the seller. A plurality of security settings 58 associated with the seller profile may also permit the seller to make the seller profile non-visible to the users of the system for communication 10, to not reveal a plurality of geographical locations associated with the seller, to direct the operations server 26 on how to generate the offer, to select how the system for communication 10 interacts with the remote application 22, to select portions of the seller profile to share with the potential buyer, and to select how the seller receives notifications.

The potential buyer profile includes data entered by the potential buyer and a plurality of operations server settings 59 used by the operations server 26 to determine how the operations server 26 performs searches on the system for communication 10. As non-limiting examples, the potential buyer profile may include the contact information 50 of the potential buyer, the transaction history 54 with respect to the system for communication 10, and a feedback 56 from users who have sold goods or services to the potential buyer. The plurality of security settings 58 associated with the potential buyer profile may also permit the potential buyer to make the potential buyer profile non-visible to the users of the system for communication 10, to not reveal geographical locations associated with the potential buyer, to direct the operations server 26 on how the operations server 26 performs searches on the system for communication 10, to select portions of the potential buyer profile to share with the seller, and to select how the potential buyer sends notifications.

FIG. 4 illustrates the process by which a seller 60 generates an offer 61 using the system for communication 10. A first user input 62 supplied by the seller 60 comprises information used by the operations server 26 to create the offer 61 which is stored on the data storage device 28 and published by the operations server 26. The first user input 62 comprises at least a first geographical location 64 and a text description 65. The first user input 62 may also comprise an image 66, a price value 68, an audio clip 70, or a video clip 72. The operations server 26 receives the first user input 62 using a form generated by the operations server 26 and accessed using the client interface 24 or through an application installed on the mobile wireless device 14.

The first geographical location 64 is determined using a receiver in the mobile wireless device 14 able to receive signals from a global positioning system. The first geographical location 64 corresponds to a location of the mobile wireless device 14. Alternately, the first geographical location 64 may be entered manually using latitudinal and longitudinal co-ordinates, using the remote application 22 (such as selecting a point on a map corresponding to a desired location, for example), using a peripheral able to receive signals from the global positioning system in communication with the user machine 20, or by accessing geographical information supplied by one of the wireless data network 18 and the network 16.

The text description 65 is supplied by the user and comprises at least one word. Preferably, the text description 65 describes the good or the service the offer 61 is associated with. The text description 65 may be subdivided into a plurality of different fields such as, but not limited to, a title field, a main description field, and an indexing terms field. Typically, the seller 60 may include additional information such as terms associated with a potential transaction, a contact information of the seller 60, and additional information the seller 60 deems relevant to the offer 61. The text description 65 may be processed by the operations server 26 or the remote application 22 to generate additional information included in the offer 61. The operations server 26 or the remote application 22, upon direction by the operations server 26, may employ an algorithm to analyze the text description 65 for at least one indexing word and to associate additional words with the text description 65. The at least one indexing word may be used by the operations server 26 or the remote application 22 to one of categorize and search offers 61 stored on the data storage device 28. Further, the at least one indexing word may be used by the operations server 26 or the remote application 22 to add or suggest additional words to be included in the offer 61.

As mentioned hereinabove, the first user input 62 may also comprise the image 66, the price value 68, the audio clip 70, or the video clip 72.

Preferably, the image 66 and the video clip 72 are of the good or the service the offer 61 is associated with. The image 66 and the video clip 72 are captured by a camera integrated with the mobile wireless device 14 or are located on a storage drive of the mobile wireless device 14 or the user machine 20. Preferably, the audio clip 70 describes the good or the service the offer 61 is associated with. The audio clip 70 is captured by a microphone integrated with the mobile wireless device 14 or is located on a storage drive of the mobile wireless device 14 or the user machine 20. The image 66, the video clip 72, and the audio clip 72 may be processed by the operations server 26 or the remote application 22, at the request of the operations server 26, to generate additional information included in the offer 61. The operations server 26 or the remote application 22 may employ an image recognition analysis including an algorithm to analyze the image 66 or the video clip 72 to generate the at least one indexing word and to associate additional words with the text description 65. The operations server 26 or the remote application 22 may employ an algorithm to analyze the audio clip 70 to one of convert the audio clip 70 into a portion of the text description 65, to generate the at least one indexing word, and to associate additional words with the text description 65.

The price value 68 is an amount of currency desired by the seller 60 in exchange for the good or the service the offer 61 is associated with; however, it is understood the first user input 62 may not include the price value 68 or the price value 68 may indicate a lowest acceptable currency amount for the good or the service the offer 61 is associated with.

In use, the seller 60 uses the system for communication 10 to post the offer 61 for the good or the service the seller 60 desires to sell and to communicate with the potential buyer 62. The potential buyer 62 uses the system for communication 10 to search and/or browse the offers 61 published to the system for communication 10 and to communicate with the seller 60.

With renewed reference to FIGS. 1 and 2, to publish the offer 61 to the system for communication 10, the seller 60 first logs in to the system for communication 10 using the log in function 32 and the username and password combination that is recognized by the operations server 26. Logging in to the system for communication 10 may be performed using the mobile wireless device 14 or the user machine 20. When the seller 60 is using the mobile wireless device 14, the seller 60 may be logged into the system for communication 10 by launching an application installed on the mobile wireless device 14 or by entering a uniform resource locator (URL) into a browser application of the mobile wireless device 14, prompting the seller 60 to log in to the system for communication 10 or logging the seller 60 in by recognizing a “cookie” on the mobile wireless device 14. When the seller 60 is using the user machine 20, the seller 60 may be logged into the system for communication 10 by entering a uniform resource locator (URL) into a browser application of the user machine 20, prompting the seller 60 to log in to the system for communication 10 or logging the seller 60 in by recognizing a “cookie” on the user machine 20. Once logged in to the system for communication 10, the seller 60 has access to the functions 34, 36, 38, 40, 41 provided by the application platform 12, as shown in FIG. 2.

To generate the offer 61, the seller 60 must provide the operations server 26 with the first user input 62, as shown in FIG. 4. By selecting a portion of the client interface 24, the seller 60 directs the operations server 26 to accept the first user input 62. The first user input 62 supplied by the seller 60 is processed by the operations server 26. As non-limiting examples, the operations server 26 may perform the functions of generating the offer 61 to be published by the applications platform 12, maintaining the user profiles 43 stored on the data storage device 28, generating the indexing words and the text descriptions 65 from the first user input 62, processing payments associated with use of the application platform 12 by the user 30, communicating with the remote application 22, and performing administrative functions as directed by the user 30 or an operator of the application platform 12.

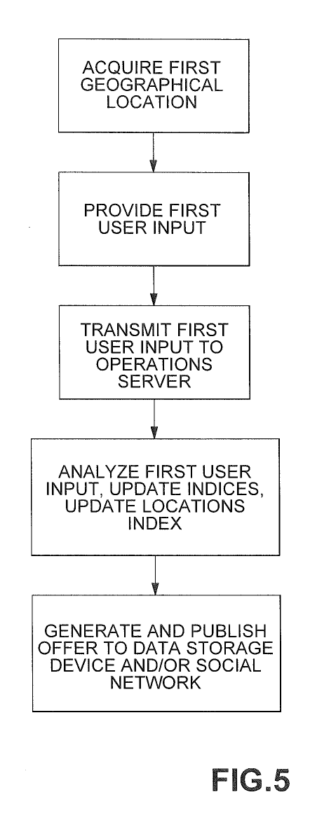

FIG. 5 illustrates an exemplary procedure by which the seller 60 interacts with the system for communication 10 to generate the offer 61. When the seller 60 is using the mobile wireless device 14 able to receive signals from a global positioning system, the operations server 26 requests the first geographical location 64 from the mobile wireless device 14 to include the first geographical location 64 in the first user input 62. It is understood that the first geographical location 64 may correspond to a location of the seller 60 or a location of the good or the service the seller 60 desires to sell, and the first user input 62 may designate whether the first geographical location 64 corresponds to a location of the seller 60 or a location of the good or the service. Alternately, the operations server 26 requests the first geographical location 64 from the seller 60 as mentioned hereinabove.

Following determination of the first geographical location 64, the operations server 26 may direct the mobile wireless device 14 to capture the image 66 of the first user input 62 using the camera integrated with the mobile wireless device 14. Typically, the image 66 of the first user input 62 is an image of the good or an image related to the service the seller 60 desires to sell. Alternately, the operations server 26 may direct the seller 60 to select the image 66 of the first user input 62 from a storage drive of the mobile wireless device 14. When the seller 60 is using the user machine 20, the operations server 26 may direct the seller 60 to select the image 66 of the first user input 62 from the storage drive of the user machine 20. As mentioned hereinabove, the operations server 26 or the remote application 22 may perform an image recognition analysis on the image 66 of the first user input 62.

Upon selection of the image 66 of the first user input 62, the operations server 26 directs the seller 60 to supply the text description 65 of the first user input 62. The seller 60, using any conventional input method associated with the mobile wireless device 14 or the user machine 20, supplies the text description 65 of the first user input 62. Non-limiting examples of conventional text input methods are keyboard entry, touchscreen text entry, predictive text entry, and speech to text conversion. Typically, the text description 65 of the first user input 62 describes the good or service the seller 60 desires to sell using the system for communication 10. As mentioned hereinabove, the text description 65 may be processed by the operations server 26 or the remote application 22 to generate additional information to be included in the offer 61.

Lastly, the operations server 26 directs the seller 60 to supply the price value 68 of the first user input 62. As mentioned hereinabove, the seller 60 may use any conventional input method associated with the mobile wireless device 14 or the user machine 20 to supply the price value 68 of the first user input 62.

Alternately, where the good or the service the seller 60 desires to sell has been previously sold using the system for communication 10, the seller 60 may access at least a portion of the first user input 62 associated with the good or the service the seller 60 desires to sell used in a previous offer. The operations server 26 may maintain a trade history of a particular good sold using the system for communication 10. The operations server 26 may be configured with a rewards system application (not shown) to incentivize use of the system for communication 10 by the seller 60 or the potential buyer. The rewards system application may allow the seller 60 or the potential buyer to purchase, earn, and redeem system credits that may be exchanged for use of at least a portion of the system for communication 10, use of the system for communication 10 without a presence of advertisements, goods offered by vendors associated with the system for communication 10, and discounts offered by vendors associated with the system for communication. As non-limiting examples, the rewards system may provide the seller 60 or the potential buyer with a predetermined number of system credits for selling a previously transacted good for a value greater than previously purchased for, for conducting a specified number of transactions within a predetermined time period, for referring a seller or a potential buyer to register with the system for communication, or for referring a seller or a potential buyer from the social network, for example.

Upon receipt of the first user input 62, the seller 60 directs the operations server 26 to publish the first user input 62 as the offer 61 for the good or service the seller 60 desires to sell. The seller 60 may direct the operations using a “post,” a “list,” or a similar command displayed by the client interface 24.

Upon direction by the seller 60 to publish the offer 61 for the good or the service the seller 60 desires to sell, the operations server 26 generates the offer 61 based on the first user input 62. The operations server 26 or the remote application 22 generates the offer 61 and stores the offer 61on the data storage device 28, where the offer 61 may be retrieved upon request by the operations server 26 in response to the search performed by the potential buyer, modified or removed at the request of the seller 60, or modified or removed by the operations server 26.

As mentioned hereinabove, the operations server 26 or the remote application 22, upon direction of the operations server 26, employs the algorithm to analyze the text description 65 to identify indexing words and to generate additional information to be included in the offer 61. Additionally, the operations server 26 may update a plurality of indices stored on the data storage device 28 with the first user input 62 or the information to be included in the offer 61. The offer 61 is associated with the information included in the plurality of indices stored on the data storage device 28, allowing the offer 61 to be retrieved in response to the search performed by the potential buyer for the information included in the plurality of indices. The first geographical location 64 of the first user input 62 is added to a locations index stored on the data storage device 28. It is understood that each of the first geographical locations 64 stored on the locations index may indicate whether each of the first geographical locations 64 correspond to the location of the seller 60 or the location of the good or the service the seller 60 desires to sell for identification by the operations server 26. Alternately, a seller locations index corresponding to the first geographical location 64 of the seller 60 and a goods and services locations index corresponding to the first geographical location 64 of the good or the service the seller 60 desires to sell may be maintained by the operations server 26.

As mentioned hereinabove, the operations server 26 or the remote application 22, upon direction of the operations server 26, may employ an image recognition analysis including an algorithm to analyze the image 66 or the video clip 72 to generate additional information to be included in the offer 61. Additionally, the operations server 26 may update the plurality of indices stored on the data storage device 28 with the additional information generated by the image recognition analysis. The offer 61 is associated with the additional information generated by the image recognition analysis included in the plurality of indices stored on the data storage device 28, allowing the offer 61 to be retrieved in response to the search performed by the potential buyer for the information included in the plurality of indices.

As mentioned hereinabove, the operations server 26 or the remote application 22, upon direction of the operations server 26, may employ the algorithm to analyze the audio clip 70 to one of convert the audio clip 70 into a portion of the text description 65, to generate at least one indexing word, and to associate additional words with the text description 65. Additionally, the operations server 26 may update the plurality of indices stored on the data storage device 28 with the additional information generated by the algorithm used to analyze the audio clip 70. The offer 61 is associated with the additional information generated by the algorithm used to analyze the audio clip 70 included in the plurality of indices stored on the data storage device 28, allowing the offer 61 to be retrieved in response to the search performed by the potential buyer for the information included in the plurality of indices.

Depending on the plurality of operation server settings 48 and the plurality of security settings 58 of the user profile 43, the operations server 26 may interact with the remote application 22 to publish the offer 61 outside of the system for communication 10. The operations server 26, using the contact information 50, the first geographical location 52, and the plurality of security settings 58 entered into the seller profile, may publish at least a portion of the offer 61 to the remote application 22, such as a social network (not shown) associated with the seller 60. Where the plurality of operation server settings 48 and the plurality of security settings 58 of the user profile 43 dictate publishing the portion of the offer 61 to the social network associated with the seller 60, the operations server 26 uses the plurality of security settings 58 to access the social network associated with the seller 60 and publish at least a portion of the offer 61 to the social network. The portion of the offer 61 published to the social network may be a hyperlink to the offer 61 published on the system for communication 10 or a second offer (not shown) configured for the social network. The portion of the offer 61 published to the social network may be a portion of a news feed, a profile, a message, or other communicative feature of the social network. Further, it is understood the operations server 26 or the remote application 22 may perform an analysis on information obtained from the social network, such as information located in a social network profile of the seller 60 or information located in a social network profile of another member of the social network accessible by the seller 60. The analysis on information obtained from the social network may be used to suggest offers 61 to the seller, to suggest offers 61 to members of the social network accessible by the seller 60, and to suggest offers 61 created by the seller 60 to members of the social network accessible by the seller 60. Such suggestions may be based on the information obtained from the social network, such as keyword searches, user interests, biographical information, and user preferences for music, movies, television, and books.

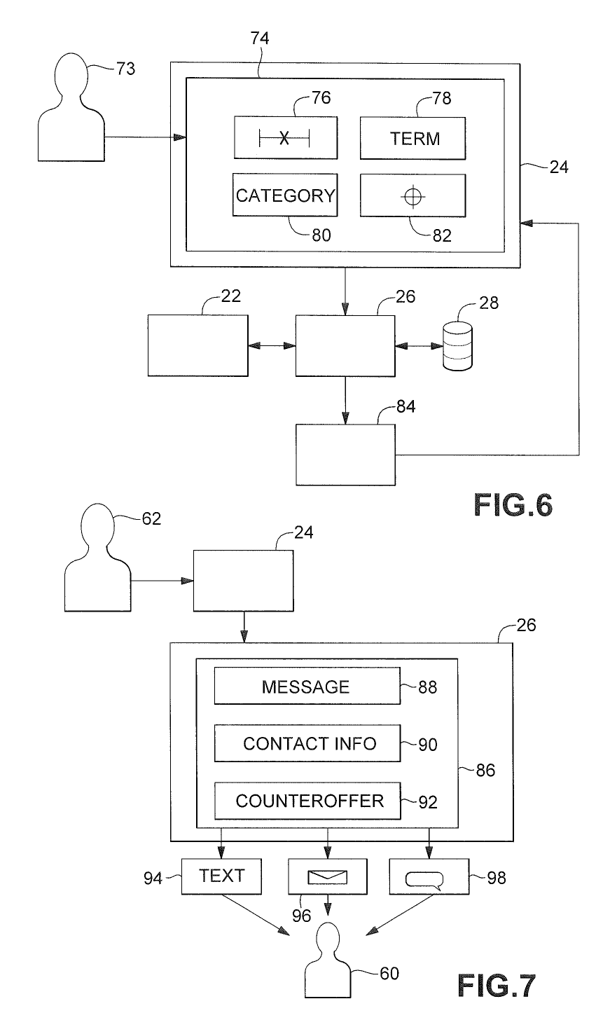

FIG. 6 illustrates the process by which a potential buyer 73 performs a search or browses for the offer 61 using the system for communication 10. Upon publication of the offer 61 to the system for communication 10 or the social network associated with the seller 60, the potential buyer 73 may locate the offer 61. Where the offer 61 is published to the social network associated with the seller 60, the potential buyer 73 may access the offer 61 by selecting the hyperlink to the offer 61 published on the social network. To locate the offer 61 using the operations server 26, the potential buyer 73 may search or browse the system for communication 10 or view the portion of the offer 61 published to the social network associated with the seller 60. As mentioned hereinabove and illustrated in FIG. 2, the system for communication 10 may be configured to only permit the potential buyer 73 who is logged into the system for communication 10 using a username and password combination that is recognized by a log in function 32 of the operations server 26 to search or browse the offers 63 located on the system for communication 10. Alternately, it is understood that the system for communication 10 may be configured to permit anyone who has access to the network 16 to search or browse the system for communication 10. Logging in to the system for communication 10 may be performed using the mobile wireless device 14 or the user machine 20. When the potential buyer 73 is using the mobile wireless device 14, the potential buyer 73 may be logged into the system for communication 10 by launching an application installed on the mobile wireless device 14 or by entering a uniform resource locator (URL) into a browser application of the mobile wireless device 14, prompting the potential buyer 73 to log in to the system for communication 10 or logging the potential buyer 73 in by recognizing a “cookie” on the mobile wireless device 14. When the potential buyer 73 is using the user machine 20, the potential buyer 73 may be logged into the system for communication 10 by entering a uniform resource locator (URL) into a browser application of the user machine 20, prompting the potential buyer 73 to log in to the system for communication 10 or logging the potential buyer 73 in by recognizing a “cookie” on the user machine 20.

FIG. 6 illustrates the process by which the potential buyer 73 searches or browses for the offer 63 using the system for communication 10. Once logged in to the system for communication 10, the potential buyer 73 has access to the functions 34, 36, 38, 40, 41 provided by the application platform 12. To browse or search for the offer 63, the potential buyer 73 must provide the operations server 26 with a second user input 74. The second user input 74 may include a distance variable 76 within which the potential buyer 73 desires to search or browse the offers 63, at least one search term 78, and a categorical selection 80. The categorical selection 80 corresponds to at least one indexing term recognized by the operations server 26. By selecting a portion of the client interface 24, the potential buyer directs the operations server 26 to accept the second user input 74.

When the potential buyer 73 is using the mobile wireless device 14 able to receive signals from the global positioning system, the operations server 26 requests a second geographical location 82 from the mobile wireless device 14 to include the second geographical location 82 in the second user input 74. The second geographical location 82 corresponds to a location of the mobile wireless device 14 used by the potential buyer 73 or a location designated by the potential buyer 73 to search within a predetermined distance from. Alternately, the second geographical location 82 may be entered manually using latitudinal and longitudinal co-ordinates, using the remote application 22 (such as selecting a point on a map corresponding to a desired location, for example), using a peripheral able to receive signals from the global positioning system in communication with the user machine 20, or by accessing geographical information supplied by one of the wireless data network 18 and the network 16.

Upon receipt of the second geographical location 82, the potential buyer 73 may supply the operations server 26 with the distance variable 76. The distance variable 76 is a distance within which the potential buyer 73 desires to perform a search or browse the offers 63. Upon receipt of the distance variable 76 by the operations server 26, the operations server 26 or the remote application 22 calculates a distance between the second geographical location 82 and each of the location in the locations index stored on the data storage device 28. To facilitate such a calculation, a portion or a plurality of portions of the location index known to be a greater distance from the second geographical location 82 than the distance variable 76 may be excluded from the calculation. Once the operations server 26 or the remote application 22 has calculated a distance between the second geographical location 82 and each of the location in the locations index, the operations server 26 or the remote application 22 generates a results list 84 for the potential buyer. The results list 84 includes each of the locations in the locations index having a distance from the second geographical location 82 that are less than or equal to the distance variable 76. The results list 84 is then displayed to the potential buyer 73 using the client interface 24. Upon display of the results list 84 using the client interface 24, the potential buyer 73 may browse the offers in the results list 84(such as through a list or as a series of points on a map, for example), provide a second distance variable different from the distance variable 76, or search within the results list 84 using at least one search term different from the at least one search term 78 or by selecting a categorical selection different from the categorical selection 80.

Alternately, the second user input 74 may be the at least one search term 78. Upon receipt of the at least one search term 78 by the operations server 26, the operations server 26 or the remote application 22 searches the offers 61 on the data storage device 28 for identical or similar terms located in the offers 61. To facilitate the search, a portion or a plurality of portions of the offers 61 may be excluded from the search based on the at least one indexing word. Once the operations server 26 or the remote application 22 has searched the offers 61 on the data storage device 28 for identical or similar terms located in the offers 61, the operations server 26 or the remote application 22 generates a preliminary results list (not shown). The preliminary results list is then sorted by the operations server 26 or the remote application 22 based on a distance between the second geographical location 82 and each of the locations in the locations index stored on the data storage device 28 corresponding to each of the offers 61 on the preliminary results list to generate the results list 84. The results list 84 is then displayed to the potential buyer 73 using the client interface 24. Upon display of the results list 84 using the client interface 24, the potential buyer 73 may browse the offers 61 in the results list 84 (such as through a list or as a series of points on a map, for example), provide a search distance to the operations server 26 to narrow the results list 84 within the search distance, or search within the results list 84 by selecting the categorical selection 80.

Alternately, the second user input 74 may be the categorical selection 80. Upon receipt of the categorical selection 80 by the operations server 26, the operations server 26 or the remote application 22 excludes offers 61 located on the data storage device 28 based on the at least one indexing word. Once the operations server 26 or the remote application 22 has excluded offers 61 located on the data storage device 28 based on the at least one indexing word, the operations server 26 or the remote application 22 generates a preliminary results list (not shown). The preliminary results list is then sorted by the operations server 26 or the remote application 22 based on a distance between the second geographical location 82 and each of the locations in the locations index stored on the data storage device 28 corresponding to each of the offers 61 on the preliminary results list to generate the results list 84. The results list is then displayed to the potential buyer 73 using the client interface 24. Upon display of the results list 84 using the client interface 24, the potential buyer 73 may browse the offers 61 in the results list 84 (such as through a list or as a series of points on a map, for example), provide a search distance to the operations server 26 to narrow the results list 84 within the search distance, or search within the results list 84 using at least one search term different from the at least one search term 78.

Upon selection of one of the offers 61 displayed in the results list 84, the operations server 26 retrieves the offer 61 from the data storage 28 device and displays the offer 61 on one of the mobile wireless device 14 or the user machine 20. After further review of the offer 61 (such as by reviewing the first geographical location 64, the user profile 43 of the seller 60, the text description 65, the image 66, the video clip 72, or the price value 68), the potential buyer 73, by selecting a portion of the user interface 24, may send a notification 86 to the seller 60 or display a plurality of contact options to send the notification 86 to the seller 60. The notification 86 may comprise a message 88 written by the potential buyer 73, a contact information 90 of the potential buyer 73, and a counteroffer 92 suggesting a second price value (not shown). The message 88 written by the potential buyer 73 may be a text message 94 sent via the wireless data network 18, an electronic mail 96 sent to an email address of the seller 60, or a message 98 stored in the application platform 12 for the seller 60.

When the potential buyer 73 chooses to send the notification 86 comprising the contact information 90 of the potential buyer 73, the operations server 26 generates the notification 86 using the user profile 43 of the potential buyer 73. Alternately, the potential buyer 73 may enter the contact information 90 such as a phone number or an email address of the potential buyer 73. The notification 86 comprising the contact information 90 of the potential buyer 73 may be generated in accordance with the plurality of operation server settings 48 and the plurality of security settings 58 of the user profile 43 of the potential buyer 73, which may exclude portions of the user profile 43 of the potential buyer 73 or the second geographical location 82 from the notification 86 sent to the seller 60.

When the potential buyer 73 chooses to send the notification 86 comprising the counteroffer 92 suggesting the second price value, the operations server 26 requests the second price value as desired by the potential buyer 73 and generates the notification 86. The notification 86 comprising the counteroffer 92 suggesting the second price value may be generated in accordance with the plurality of operation server settings 48 and the plurality of security settings 58 of the user profile 43 of the potential buyer 73, which may exclude portions of the user profile 43 of the potential buyer 73 or the second geographical location 82 from the notification 86 comprising the counteroffer 92 suggesting the second price value.

When the potential buyer 73 chooses to send the notification 86 comprising the message 98 written by the potential buyer 73, the operations server 26 requests the message 98 from the potential buyer 73 and generates the notification 86. The notification 86 comprising the message 98 written by the potential buyer 73 may be generated in accordance with the plurality of operation server settings 48 and the plurality of security settings 58 of the user profile 43 of the potential buyer 73, which may exclude portions of the user profile 43 of the potential buyer 73 or the second geographical location 82 from the notification 86 comprising the message 98 written by the potential buyer 73. The operations server 26 or the remote application 22 may send the notification 86 comprising the message 98 written by the potential buyer 73 as the text message 94 delivered to the mobile wireless device 14 of the seller 60, as the electronic mail 96 sent to the email address of the seller 60, or as the message 98 stored in the application platform 12 for the seller 60. Alternately, the operations server 26 may send the notification 86 comprising a notice to the seller 60 of the message 98 stored in the application platform 12 for the seller 60. Further, in accordance with the plurality of operation server settings 48 and the plurality of security settings 58 of the user profile 43 of the seller 60, the operations server 26 may provide the potential buyer 73 with a contact information such as the phone number or the email address of the seller 60 in response to the potential buyer 73 directing the operations server 26 to send the notification 86 to the seller 60.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. A method of communication between a seller and a potential buyer, the steps of the method comprising:
providing at least one server in communication with a wireless data network;
receiving at the at least one server a first user input from the seller, the first user input including a first geographical location associated with the seller;
publishing an offer to the at least one server, the offer including at least a portion of the first user input from the seller;
communicating a second geographical location to the at least one server using the wireless data network, the second geographical location associated with a mobile wireless device of the potential buyer;
calculating a distance between the first geographical location and the second geographical location; and
determining by the at least one server whether the offer may be viewed on the wireless mobile device based on the distance between the first geographical location and the second geographical location; and
viewing the offer by the potential buyer on the mobile wireless device, wherein the distance between the first geographical location and the second geographical location is less than or equal to a pre-selected distance of the potential buyer.

2. The method of communication according to claim 1, wherein the mobile wireless device is a mobile phone.

3. The method of communication according to claim 1, wherein the step of publishing the offer to the at least one server includes displaying at least a portion of the first user input based on a preference of the seller.

4. The method of communication according to claim 1, further comprising the step of receiving at the at least one server a second user input from the potential buyer, the at least one server sending a notification to the seller in response to the second user input from the potential buyer.

5. The method of communication according to claim 4, wherein the notification comprises one of a message written by the potential buyer, a contact information of the potential buyer, and a counteroffer to the offer.

6. The method of communication according to claim 5, wherein the notification is one of a text message sent to a second mobile wireless device of the seller, an electronic mail sent to an email address of the seller, and a message residing on the at least one server.

7. The method of communication according to claim 1, wherein the step of publishing the offer to the at least one server further includes publishing at least a portion of the offer to a social network associated with the seller.

8. The method of communication according to claim 1, wherein the step of publishing the offer to the at least one server further includes publishing at least a portion of the offer with at least one indexing term.

9. The method of communication according to claim 1, wherein the first user input includes at least one of an image, an audio clip, a text description, and a price value.

10. The method of communication according to claim 9, wherein the step of receiving at the at least one server the first user input from the seller further includes performing a speech recognition analysis on the audio clip included in the first user input.

11. The method of communication according to claim 9, wherein the step of receiving at the at least one server the first user input from the seller further includes performing an image recognition analysis on the image in the first user input.

12. The method of communication according to claim 1, further comprising the step of storing the first geographical location on the at least one server, the first geographical location stored on the at least one server associated with a profile of the seller stored on the at least one server.

13. A method of communication between a seller and a potential buyer, the steps of the method comprising:
providing at least one server in communication with a wireless data network;
receiving at the at least one server a first user input from the seller, the first user input including a first geographical location associated with the seller and at least one of an image, an audio clip, a text description, and a price value;
publishing an offer to the at least one server, the offer including at least a portion of the first user input from the seller and at least one indexing term;
receiving at the at least one server a second geographical location using the wireless data network, the second geographical location associated with a mobile wireless device of the potential buyer;
calculating a distance between the first geographical location and the second geographical location;
determining by the at least one server whether the offer may be viewed on the wireless mobile device based on the distance between the first geographical location and the second geographical location;
viewing the offer by the potential buyer on the mobile wireless device; and
receiving at the at least one server a second user input from the potential buyer using the wireless data network, the at least one server sending a notification to the seller in response to the second user input from the potential buyer, wherein the distance between the first geographical location and the second geographical location is less than or equal to a pre-selected distance of the potential buyer.

14. A system for communication between a seller and a potential buyer, the system comprising:
at least one server in communication with a wireless data network, the at least one server configured to receive and store a first user input from the seller, the first user input including a first geographical location associated with the seller, the at least one server publishing an offer to the server, the offer including at least a portion of the user input from the seller; and
a mobile wireless device in communication with the at least one server using the wireless data network, the mobile wireless device providing a second geographical location to the at least one server, the second geographical location associated with the potential buyer, wherein the at least one server calculates a distance between the first geographical location and the second geographical location, the at least one server determining whether the offer may be viewed on the wireless mobile device based on the distance between the first geographical location and the second geographical location, the at least one server making the offer viewable to the mobile wireless device when the distance between the first geographical location and the second geographical location is less than or equal to a pre-selected distance of the potential buyer.

15. The system for communication according to claim 14, wherein the mobile wireless device is a mobile phone.

16. The system for communication according to claim 14, wherein the at least a portion of the first user input included in the offer published to the at least one server is based on a preference of the seller.

17. The system for communication according to claim 14, wherein the at least one server receives a second user input from the potential buyer and the at least one server, in response to the second user input, sends a notification to the seller.

18. The system for communication according to claim 17, wherein the notification comprises one of a message written by the potential buyer, a contact information of the potential buyer, and a counteroffer to the offer.

19. The system for communication according to claim 14, wherein the at least a portion of the first user input included in the offer published to the at least one server includes at least one indexing term.

20. The system for communication according to claim 14, wherein the at least one server publishes at least a portion of the offer to a social network associated with the seller.
